(19) United States
(12) Patent Application Publication
(10) Pub. No.: US 2026/0292807 A1
(43) Pub. Date: Sep. 24, 2026

(54) BASE STATION RESOURCE SCHEDULING OUTSIDE BANDWIDTH PART

(71) Applicant: T-Mobile USA, Inc., Bellevue, WA (US)

(72) Inventors: Roopesh Kumar Polaganga, Bothell, WA (US); Amembal Vikram Pai, Bothell, WA (US); Kurt M Landuyt, Parkville, MO (US); Priyanka Bhardwaj, Renton, WA (US)

(21) Appl. No.: 19/088,172

(22) Filed: Mar. 24, 2025

(51) Int. Cl. H04W 72/0457; H04W 52/36; H04W 72/12; H04W 72/51

(52) U.S. Cl. CPC H04W 72/0457; H04W 52/367; H04W 72/12; H04W 72/51

(57) ABSTRACT

A base station of a telecommunication network provides a carrier that includes bandwidth parts, and monitors utilization of the bandwidth parts. When utilization of a particular bandwidth part exceeds a utilization threshold, the base station identifies a high data user equipment (UE) assigned to the particular bandwidth part. If the base station determines that the high data UE is capable of accessing additional resources outside the particular bandwidth part, that base station may instruct the high data UE to use the additional resources outside the particular bandwidth part in addition to allocated resources of the particular bandwidth part.

### BACKGROUND

In a telecommunication network, a user equipment (UE) may wirelessly connect to one or more base stations associated with the telecommunication network. For example, a UE may wirelessly connect to one or more gNBs or other base stations of a radio access network (RAN) to access the telecommunication network.

When a UE connects to the telecommunication network via a base station, the base station may allocate resources to the UE. The UE may accordingly use the allocated resources to engage in voice calls, video calls, data transfers, or other types of communications while the UE is connected to the base station.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 shows an example of a network environment in which UEs may connect to a telecommunication network via a base station.

FIG. 2 shows an example of a system architecture for the base station, in accordance with various examples.

FIG. 3 shows a flowchart of an example method for causing high data UEs assigned to a BWP to use additional resources outside that BWP.

FIG. 4 shows a flowchart of an example method for causing high data UEs assigned to one BWP to use additional resources outside that BWP that may also be associated with a different BWP and with an LTE eNB via DSS.

### DETAILED DESCRIPTION

UEs, such as mobile phones or other types of user equipment, may connect to telecommunication networks to engage in voice calls, video calls, data transfers, or other types of communications. For example, a UE may wirelessly connect to a base station of a telecommunication network, such as a gNB of a fifth generation (5G) New Radio (NR) radio access network. When connected to the base station, the UE may send uplink data to the base station and receive downlink data from the base station, in order to send and receive data, make and receive calls, and/or perform other operations via the telecommunication network.

The telecommunication network may, via base stations, be able to exchange data with UEs using frequencies within one or more spectrum bands. For instance, the telecommunication network may define one or more carriers within available spectrum bands. UEs may accordingly be able to use one or more carriers to send and receive data via the telecommunication network.

The telecommunication network may also associate different contiguous sets of physical resource blocks (PRBs) within a single carrier with different Bandwidth Parts (BWPs). As an example, in 5G NR a particular carrier may have a bandwidth of up to 400 MHz. Different sets of PRBs within a single carrier may be associated with different BWPs, such that different BWPs within the same carrier may be associated with different ranges of frequencies. As an example, a first BWP may extend across frequencies within a 30 MHz bandwidth within a carrier, while a second BWP may extend across frequencies within a 20 MHz bandwidth within the same carrier.

The telecommunication network may assign different sets of UEs to different BWPs. The telecommunication network may also allocate resources, such as PRBs, associated with the BWPs to the UEs that are assigned to the respective BWPs. Accordingly, a UE that is assigned to a particular BWP may monitor and use resources within the bandwidth range of that particular BWP. For instance, a first UE assigned to use a 20 MHz BWP may monitor the frequencies within the corresponding 20 MHz range associated with that BWP, while a second UE assigned to use a different 30 MHz BWP may monitor a larger range of frequencies within the corresponding 30 MHz range associated with that BWP.

UEs may be assigned to different BWPs at least in part based on the capabilities of the UEs. As an example, most 5G-compatible UEs may be capable of using 20 MHz BWPs, while a smaller set of newer 5G-compatible UEs may also be capable of using BWPs with bandwidths larger than 20 MHz, such as 30 MHz BWPs. In this example, many older UEs may not be capable of using a 30 MHz BWP. Accordingly, if a gNB is configured to provide both a 30 MHz BWP and a 20 MHz BWP, newer UEs may be assigned to the 30 MHz BWP while older UEs may be assigned to the 20 MHz BWP.

In some situations, issues such as congestion and/or an inefficient use of available spectrum resources may arise because some UEs may not support, and/or may not be assigned to, certain BWPs. For example, a 20 MHz BWP and a 30 MHz BWP may partially overlap within a carrier, such that the 20 MHz BWP covers frequencies in the lowest 20 MHz range of the 30 MHz BWP. In this example, the 20 MHz range shared by both BWPs may become congested. Newer UEs assigned to the 30 MHz BWP may potentially use resources in the upper 10 MHz range of that BWP that is not shared by the 20 MHz BWP to avoid or reduce congestion. However, in conventional systems older UEs assigned to the 20 MHz BWP are unable to access resources outside that assigned BWP. Accordingly, it may be difficult to reduce or avoid congestion within the smaller 20 MHz BWP.

Additionally, in this example the 10 MHz range of the carrier that is part of the 30 MHz BWP, but is not part of the 20 MHz BWP, may be underutilized. As discussed above, newer UEs assigned to the larger 30 MHz BWP may potentially use resources in that 10 MHz range. However, in conventional systems, older UEs that are assigned to the smaller 20 MHz BWP and do not support 30 MHz BWPs may be unable to use resources in the 10 MHz range that is outside the 20 MHz BWP, such that the 10 MHz range may be underutilized relative to the lower 20 MHz range shared by both BWPs.

The systems and methods described herein allow UEs assigned to a particular BWP to access and use additional resources that are outside that particular BWP. For example, if a UE is assigned to a 20 MHz BWP, in some situations a gNB may nevertheless instruct the UE to access and use additional resources outside that 20 MHz BWP. Such additional resources may also be associated with a different BWP that the UE is not assigned to use. Accordingly, the gNB may instruct a UE to use resources in an assigned BWP and additional resources outside that assigned BWP, for instance to avoid or reduce congestion in that BWP and/or to more efficiently use resources that are outside the BWP.

### Example Environment

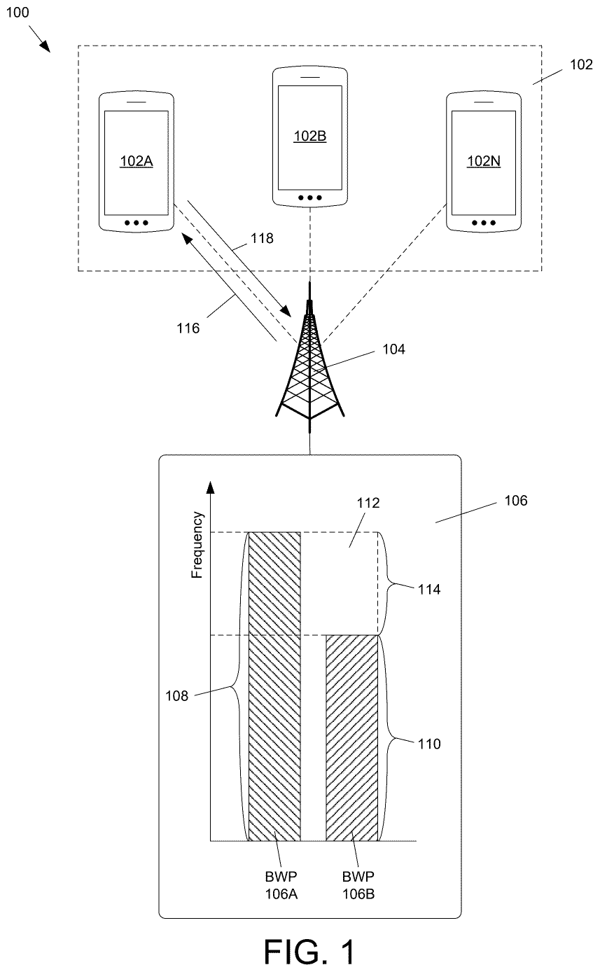

FIG. 1 shows an example 100 of a network environment in which UEs 102 may connect to a telecommunication network via a base station 104. The UEs 102 may include multiple different UEs 102, such as UE 102A, UE 102B, . . . and UE 102N as shown in FIG. 1. When a UE 102 connects to the telecommunication network via the base station 104 and/or other base stations or access points, the UE 102 may engage in communication sessions for voice calls, video calls, messaging, data transfers, and/or any other type of communication via the telecommunication network.

The UEs 102 may be devices configured to wirelessly connect to base stations 104 and/or other access points associated with the telecommunication network, such that the UEs 102 may connect to the telecommunication network. In some examples, a user equipment (UE) 102 may be a mobile phone, such as a smart phone or other cellular phone. In other examples, a UE 102 may be a personal digital assistant (PDA), a media player, a tablet computer, a gaming device, a smart watch, a hotspot, an Internet of Things (IoT) device, a personal computer (PC) such as a laptop, desktop, or workstation, or any other type of computing or communication device.

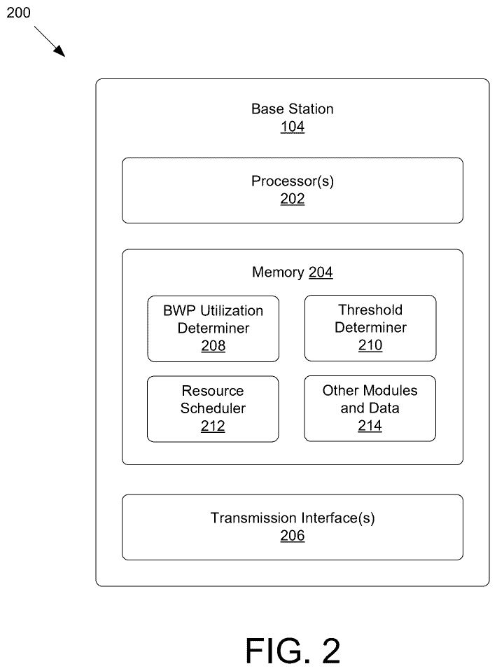

The base station 104 may be part of an access network of the telecommunication network, such as a radio access network (RAN), that includes base stations and/or other access points to which UEs 102 may connect. Although one base station 104 is shown in FIG. 1, the access network may include multiple base stations 104. An example system architecture for the base station 104 is discussed further below with respect to FIG. 2.

The telecommunication network may also have a core network linked to the base station 104 and/or other elements of an access network. A UE 102 may wirelessly connect to a base station 104 of the access network, and in turn be connected to the core network via the base station 104. The core network may also link the UE 102 to an Internet Protocol (IP) Multimedia Subsystem (IMS), the Internet, and/or other networks.

UEs 102 and elements of the telecommunication network, such as the base station 104, other elements of the access network, and/or the core network, may be compatible with one or more radio access technologies, wireless access technologies, protocols, and/or standards. For example, UEs 102, the base station 104, other elements of the access network, and/or the core network may support 5G NR technology, Long-Term Evolution (LTE)/LTE Advanced technology, other fourth generation (4G) technology, High-Speed Data Packet Access (HSDPA)/Evolved High-Speed Packet Access (HSPA+) technology, Universal Mobile Telecommunications System (UMTS) technology, Code Division Multiple Access (CDMA) technology, Global System for Mobile Communications (GSM) technology, WiMax® technology, WiFi® technology, and/or any other previous or future generation of radio access technology.

As an example, the base station 104 may be a gNB of a 5G access network. Accordingly, UEs 102 that support 5G technologies may connect to such a 5G gNB. UEs 102 may also, or alternately, connect to other gNBs, to evolved Node Bs (eNBs) of an LTE access network, and/or to other types of base stations and/or access points. The core network may also be based on LTE or 5G. For example, the base station 104 may be a gNB of a 5G access network that connects to a 5G core network and/or to an LTE packet core network known as an Evolved Packet Core (EPC).

UEs 102 may transmit data to, and/or receive data from, the base station 104. For example, a UE 102 may receive downlink transmissions from the base station 104, for instance to download data, receive voice and/or video data during calls, and/or receive any other type of data. As another example, a UE 102 may send uplink transmissions to the base station 104 to upload data, submit requests for services, transmit voice and/or video data during calls, and/or to transmit any other type of data from the UE 102 to the base station 104, the core network, an IMS, the Internet, and/or other networks. A UE 102 may establish a Radio Resource Control (RRC) connection with the base station 104, such that the UE 102 and the base station 104 may use the RRC connection for downlink and/or uplink transmissions.

The base station 104 and UEs 102 may support data transmissions at frequencies in one or more spectrum bands. For example, the base station 104 and/or individual UEs 102 may support transmissions at low band frequencies under 1 GHz, mid-band frequencies between 1 GHz and 6 GHz, and/or high band frequencies above 6 GHz, including millimeter wave (mmW) frequencies above 24 GHz.

The base station 104 may be configured to provide one or more carriers, within one or more spectrum bands, that may be used by UEs 102 that support those carriers. Carriers may have bandwidths associated with corresponding frequency ranges. For example, although LTE carriers may have maximum bandwidths of 20 MHz, 5G NR carriers may have larger bandwidths, such as carriers of up to 100 MHz in Time Division Duplex (TDD) bands and carriers of up to 400 MHz in Frequency Division Duplex (FDD) bands.

The base station 104 may be configured to associate different sets of resources of a carrier with different bandwidth parts (BWPs) 106. For example, although a 5G NR carrier may have a relatively large bandwidth, smaller portions of the carrier's bandwidth may be associated with corresponding BWPs 106. Different BWPs 106 may be associated with different resources, such as different contiguous sets of physical resource blocks (PRBs) in a carrier and/or spectrum band. In some examples, different BWPs 106 may be configured to have different numerologies and/or other attributes. For instance, different BWPs 106 within the same carrier or spectrum band may have different subcarrier spacing values, which may be associated with different latency, throughput, and/or reliability metrics.

Different BWPs 106 may have different bandwidths, such that one BWP 106 may have a larger bandwidth than another BWP 106 in the same carrier. Different UEs 102 may support BWPs 106 with different bandwidths. For instance, some UEs 102 may be configured to support BWPs 106 with bandwidths of up to 20 MHz, while other UEs 102 may be configured to support BWPs 106 with bandwidths larger than 20 MHz. As an example, many early 5G NR UEs 102 were configured to support a maximum bandwidth of 20 MHz for carriers and/or BWPs 106, in some cases because LTE carriers had a maximum bandwidth of 20 MHz. However, because 5G NR allows carriers to have bandwidths larger than 20 MHz, many newer 5G NR UEs 102 are configured to support carriers and/or BWPs 106 that have bandwidths larger than 20 MHz.

The base station 104 may assign UEs 102 to use particular BWPs 106 of a carrier, based at least in part on which bandwidths the UEs 102 support for BWPs 106. As an example, if a first UE 102A only supports BWPs 106 with bandwidths of up to 20 MHz, the base station 104 may assign the first UE 102A to a BWP 106 that has a 20 MHz bandwidth. However, if a second UE 102B supports BWPs 106 with bandwidths of up to 30 MHz, the base station 104 may assign the second UE 102B to a different BWP 106 that has a 30 MHz bandwidth.

In addition to assigning UEs 102 to use particular BWPs 106 of a carrier, the base station 104 may also allocate specific resources, such as specific PRBs, within those BWPs 106 to corresponding UEs 102. Accordingly, a UE 102 assigned to a BWP 106 may use particular PRBs, within the assigned BWP 106, that the base station 104 has allocated to the UE 102 to perform a downlink or uplink transmission. As discussed further below with respect to FIG. 2, the base station 104 may include a resource scheduler and/or other elements that allocate resources to UEs 102, for instance in association with corresponding transmissions.

Because UEs 102 may be assigned to particular BWPs 106, the UEs 102 may preserve power by monitoring and using resources associated with the BWPs 106 assigned to the UEs 102, instead of monitoring and using the full set of resources associated with a larger carrier. For example, if a 5G NR carrier has a bandwidth of 100 MHz, a UE 102 may use significant power resources to monitor the full 100 MHz bandwidth of that 5G NR carrier. However, by assigning the UE 102 to a particular BWP 106 that has a smaller bandwidth, such as a particular 20 MHz or 30 MHz range within the 5G NR carrier's full 100 MHz bandwidth, the UE 102 may use fewer power resources to monitor the smaller bandwidth of the assigned BWP 106 relative to monitoring the full 100 MHz bandwidth of the 5G NR carrier.

As discussed above, different BWPs 106 may be associated with different resources, such as different contiguous sets of PRBs. In some examples, different BWPs 106 may be associated with different sets of resources that partially overlap. As an example, FIG. 1 shows that the base station 104 may be configured to provide and use both a first BWP 106A and a second BWP 106B. The first BWP 106A may have a first bandwidth 108, such that the first BWP 106A is associated with resources in a frequency range that corresponds to the first bandwidth 108. The second BWP 106B may have a second bandwidth 110 that is smaller than the first bandwidth 108 of the first BWP 106A, but that covers a portion of the larger frequency range of the first bandwidth 108 of the first BWP 106A. Although FIG. 1 shows the base station 104 providing and using two BWPs 106, the base station 104 may be configured to provide and use other BWPs 106 in addition to the first BWP 106A and the second BWP 106B.

As shown in FIG. 1, because the second bandwidth 110 of the second BWP 106B is smaller than the first bandwidth 108 of the first BWP 106A, there may be resources 112 associated with frequencies within a third bandwidth 114 that is outside the second bandwidth 110 of the second BWP 106B. The resources 112 in the third bandwidth 114 may accordingly be considered to be outside, and not be part of, the second BWP 106B. However, the resources 112 in the third bandwidth 114 may be associated with frequencies that are also within the first bandwidth 108 of the first BWP 106A. Accordingly, the first bandwidth 108 of the first BWP 106A may include both the second bandwidth 110 of the second BWP 106B and the third bandwidth 114 that is outside the second bandwidth 110 of the second BWP 106B.

As a non-limiting example, the first bandwidth 108 of the first BWP 106A may be 30 MHz, and the smaller second bandwidth 110 of the second BWP 106B may be 20 MHz. The 20 MHz second bandwidth 110 of the second BWP 106B may be a frequency range that spans the lowest 20 MHz of the 30 MHz first bandwidth 108 of the first BWP 106A. However, in this example, the highest 10 MHz of the 30 MHz first bandwidth 108 of the first BWP 106A may be outside the 20 MHz second bandwidth 110 of the second BWP 106B. The highest 10 MHz of the 30 MHz first bandwidth 108 of the first BWP 106A may be the third bandwidth 114 of resources 112 that are not part of the second BWP 106B.

In this example, the 10 MHz range associated with the third bandwidth 114 may also be a portion of the first BWP 106A. Accordingly, UEs 102 assigned to the first BWP 106A may be allocated, and use, resources 112 within the third bandwidth 114 and/or resources in any other portion of the 30 MHz first bandwidth 108. However, the resources 112 in the 10 MHz range associated with the third bandwidth 114 may be outside the 20 MHz second bandwidth 110 of the second BWP 106B, such that the resources 112 in the 10 MHz range associated with the third bandwidth 114 are not part of the second BWP 106B.

As discussed above, some UEs 102 may be capable of being assigned to, and using, the larger first BWP 106A. However, other UEs 102 may not be capable of being assigned to, and using, the larger first BWP 106A, and accordingly the base station 104 may instead assign those UEs 102 to the smaller second BWP 106B. As a non-limiting example, if the first bandwidth 108 of the first BWP 106A is 30 MHz and the second bandwidth 110 of the second BWP 106B is 20 MHz, the base station 104 may assign newer UEs 102 that support BWP bandwidths greater than 20 MHz to the first BWP 106A. However, older UEs 102 that only support BWP bandwidths of up to 20 MHz may not be capable of using the first BWP 106A, and the base station 104 may instead assign those older UEs 102 to use the second BWP 106B.

In some situations, the number of UEs 102 connected to the base station 104 that do not support the larger first BWP 106A may exceed the number of UEs 102 connected to the base station 104 that do support the larger first BWP 106A. For instance, if a significant portion of subscribers of the telecommunication network are using older legacy UEs 102 and have not upgraded to newer UEs 102 that support BWPs 106 with bandwidths greater than 20 MHz, a significant percentage or even a majority of the UEs 102 connected to the base station 104 may not be capable of using the larger first BWP 106A and may instead be assigned to the smaller second BWP 106B. This may lead to a relatively high likelihood of the second BWP 106B becoming congested, and thereby decreasing data speeds and user experiences associated with UEs 102 assigned to the second BWP 106B.

However, as described herein, the base station 104 may reduce or avoid congestion in the second BWP 106B by scheduling some UEs 102, assigned to the second BWP 106B, to use resources 112 in the third bandwidth 114 that is outside the second BWP 106B. For example, although such UEs 102 may remain assigned to the second BWP 106B, the base station 104 may cause the UEs 102 to access data via resources 112 in the third bandwidth 114 in addition to resources within the second BWP 106B.

For instance, the second BWP 106B becomes congested, the base station 104 may identify a set of high data UEs 102 that are currently assigned to the second BWP 106B. The high data UEs 102 may be using more data and/or resources than other UEs 102 currently assigned to the second BWP 106B. The base station 104 may determine whether such high data UEs 102 support cross-carrier scheduling, carrier aggregation, and/or other techniques that indicate that the high data UEs 102 are capable of accessing and using resources 112 outside the second BWP 106B, in some examples in addition to resources inside the second BWP 106B. After identifying high data UEs 102 that support techniques for accessing resources 112 outside the second BWP 106B, the base station 104 may allocate such resources 112 outside the second BWP 106B to those high data UEs 102. The base station 104 may also send scheduling messages 116 to the high data UEs 102. The scheduling messages 116 may include or indicate Downlink Control Information (DCI) and/or other information that identifies resources allocated to the high data UEs 102. Such scheduling messages 116 may accordingly instruct the high data UEs 102 to use the allocated resources 112, outside the second BWP 106B, for at least a portion of the data transmissions performed by those high data UEs 102.

As a non-limiting example, a first UE 102A may be assigned to the second BWP 106B. If the first UE 102A is streaming a high resolution video, such that the UE 102A is using more data and/or resources than most other UEs 102 assigned to the second BWP 106B, the first UE 102A may be considered to be a high data UE 102. The base station 104 may determine that the first UE 102A supports cross-carrier scheduling and/or carrier aggregation, such that the first UE 102A is capable of those or similar techniques to access and use resources 112 outside the second BWP 106B in addition to resources inside the second BWP 106B to which the first UE 102A is assigned. The base station 104 may accordingly allocate particular resources 112 in the third bandwidth 114, outside the second BWP 106B, to the first UE 102A. The base station 104 may also use resources in the second BWP 106B to send a scheduling message 116 that instructs the first UE 102A to use the additional resources 112 in the third bandwidth 114, allocated to the first UE 102A, to stream the high resolution video.

Accordingly, in this example the base station 104 may shift the majority of the downlink data transmissions associated with the first UE 102A to additional resources 112 outside of the second BWP 106B, even though the first UE 102A remains assigned to the second BWP 106B. By shifting such a high data UE 102 to use additional resources 112 outside of the second BWP 106B, overall congestion and/or utilization of the second BWP 106B may be reduced or alleviated. In this example, the first UE 102A may not support BWPs 106 with bandwidths larger than the second bandwidth 110 of the second BWP 106B, such that the first UE 102A may not be assigned to the first BWP 106A even if the base station 104 causes the first UE 102A to use additional resources 112 in the third bandwidth 114 that overlaps with a portion of the first bandwidth 108 of the first BWP 106A. However, this may increase utilization of the resources 112 in the third bandwidth 114, and thereby lead to a more efficient overall usage of the resources 112 in the third bandwidth 114 relative to only using the resources 112 in the third bandwidth 114 for UEs 102 assigned to the first BWP 106A.

The base station 104 may be configured to determine and monitor current utilizations of one or more BWPs 106, substantially in real time. For instance, the base station 104 may be configured to determine current utilizations of resources associated with BWPs 106, for instance based on how many PRBs associated with each BWP 106 the base station 104 has allocated to UEs 102 and/or how many PRBs associated with the BWPs 106 are currently being used by UEs 102.

The base station 104 may also, or alternately, be configured to predict utilization of one or more BWPs 106 during one or more future periods of time. For instance, the base station 104 may be configured to use artificial intelligence (AI), machine learning (ML) models, historical patterns, predefined rules, and/or other systems to predict future utilization of resources of individual BWPs 106, and/or to predict future times at which utilization of resources of individual BWPs 106 is likely to increase and/or decrease.

As a non-limiting example, the base station 104 may be configured to use a predictive model based on deep learning algorithms, non-linear analysis, linear analysis, convolutional neural networks, recurrent neural networks, other types of neural networks, nearest-neighbor algorithms, Random Forest algorithms, decision trees, support-vector networks, and/or other types of artificial intelligence or machine learning frameworks. The predictive model may have been trained on historical data indicating that utilization of one or more BWPs 106 tends to increase during morning and evening hours that correspond to rush hour traffic, during highly-attended sporting events near the base station 104, and/or in association with other factors. Accordingly, the base station 104 may use such a predictive model to predict that although a current utilization of a particular BWP 106 is relatively low, the utilization of that BWP 106 is likely to increase at a future time.

The base station 104 may be configured with one or more utilization thresholds that may trigger the base station 104 to cause one or more UEs 102 to use resources outside of the BWPs 106 assigned to those UEs 102, for instance if utilization of a BWP 106 exceeds or is predicted to exceed a corresponding utilization threshold. As a non-limiting example, the base station 104 may be configured with a utilization threshold of 70% for the second BWP 106B, or any other higher or lower utilization threshold.

In some examples, the utilization threshold associated with a BWP 106 may be predetermined by an operator of the base station 104 or the telecommunication network. In other examples, the base station 104 may dynamically determine the utilization threshold associated with a BWP 106. For instance, the base station 104 may be configured to use AI, ML, historical patterns, predefined rules, and/or other systems to increase and/or decrease the utilization threshold associated with a BWP 106 at certain times of day and/or in association with certain factors.

As a non-limiting example, the base station 104 may be configured to lower the utilization threshold associated with the second BWP 106B during periods of time that the base station 104 predicts are likely to be associated with a higher utilization of the second BWP 106B. Accordingly, during such periods of time, the base station 104 may become more aggressive in attempting to cause high data UEs 102 to use resources outside of the second BWP 106B. However, during other periods of time when high utilization of second BWP 106B may be less likely, the base station 104 may increase the utilization threshold associated with the second BWP 106B such that the base station 104 becomes less aggressive in attempting to cause high data UEs 102 to use resources outside of the second BWP 106B.

When a current or predicted utilization of the resources of a BWP 106 exceeds the corresponding utilization threshold for that BWP 106, the base station 104 may be configured to identify a set of UEs 102 assigned to the that BWP 106. From among the set of UEs 102 assigned to the BWP 106, the base station 104 may identify a subset of high data UEs 102 that are currently using, and/or are predicted to use, more data and/or resources than other UEs 102 in the set of UEs 102 assigned to the BWP 106. As a non-limiting example, the base station 104 may be configured to identify 10% of the UEs 102 assigned to the BWP 106 that are using more data than the other 90% of the UEs 102 assigned to the BWP 106, and to consider that 10% of the UEs 102 to be high data UEs 102. In other examples, the base station 104 may be configured to use any other percentage or number to identify a set of high data UEs 102 that are using more data than the rest of the UEs 102 assigned to a BWP 106.

In some examples, the base station 104 may be configured to use AI, ML, historical patterns, predefined rules, and/or other systems to adjust how many UEs 102 are considered to be high data UEs 102. For instance, during periods of time associated with high utilization of the second BWP 106B, the base station 104 may be configured to identify a higher percentage of UEs 102 assigned to the second BWP 106B as being high data UEs 102. However, during other periods of time associated with lower utilization of the second BWP 106B, the base station 104 may be configured to identify a lower percentage of UEs 102 assigned to the second BWP 106B as being high data UEs 102.

The base station 104 may also, or alternately, be configured to identify high data UEs 102 based on future predicted data usage of UEs 102. As an example, the base station 104 may use AI, ML, historical patterns, predefined rules, and/or other systems to determine that a particular UE 102 is likely to be a high data UE 102 in the near future, even if that UE 102 is not currently using a large amount of data. For instance, if historical patterns indicate that the UE 102 often begins streaming high resolution video at a particular time of day, the base station 104 may predict that the UE 102 is likely to become a high data UE 102 at that particular time of day. Accordingly, the base station 104 may be configured to consider that UE 102 as a predicted high data UE 102, and to use the techniques described herein to instruct the UE 102 to use resources outside of its currently-assigned BWP 106. As such, the UE 102 may use allocated resources outside its assigned BWP 106 to stream high resolution video instead of resources inside the BWP 106, thereby proactively avoiding or reducing congestion that may have otherwise been caused in part by the UE's streaming of high resolution video.

When the base station 104 identifies high data UEs 102, in response to determining that current or predicted usage of a corresponding BWP 106 exceeds a utilization threshold, the base station 104 may be configured to determine which of those high data UEs 102 supports using additional resources outside of that BWP 106. When UEs 102 connect to the base station 104, the UEs 102 may provide UE capability information 118 that identifies which spectrum bands the UEs 102 support, which bandwidths the UEs 102 support for carriers and/or BWPs 106, and/or other attributes of the UEs 102. For example, a UE 102 may provide UE capability information 118 via an RRC message or other type of message when the UE 102 initially registers with the base station 104. The base station 104 may use such UE capability information 118 to determine whether to assign individual UEs 102 to the first BWP 106A or the second BWP 106B, for instance based on whether the UEs 102 are capable of supporting the bandwidths of the first BWP 106A or the second BWP 106B. However, the base station 104 may use such UE capability information 118 to determine whether the UEs 102 support using resources outside of an assigned BWP 106, instead of or in addition to resources inside the assigned BWP 106.

For instance, UE capability information 118 may indicate that a corresponding UE 102 supports carrier aggregation. Carrier aggregation may allow the UE 102 to use resources associated with multiple carriers to send or receive data via the base station 104, for instance via intra-band contiguous carrier aggregation, intra-band non-contiguous carrier aggregation, and/or inter-band carrier aggregation. If the UE 102 supports carrier aggregation, the UE capability information 118 may also indicate which spectrum bands, carrier bandwidths, and/or carrier combinations the UE 102 supports when using carrier aggregation.

Accordingly, if the UE capability information 118 indicates that the UE 102 supports carrier aggregation, and supports a combination of carriers that could or would encompass bandwidth ranges associated with both the BWP 106 assigned to the UE 102 as well as with additional resources outside that assigned BWP 106, the base station 104 may determine that the UE 102 is capable of accessing those additional resources outside the assigned BWP 106 instead of or in addition to resources inside the assigned BWP 106. For instance, if the UE capability information 118 indicates that the UE 102 supports carrier aggregation for combinations of carriers that could or would span the full spectrum band associated with the BWPs 106, the base station 104 may determine that the UE 102 is capable of accessing resources within that spectrum band that are within one of the BWPs 106 as well as outside that BWP 106, even if the BWPs 106 are associated with the same carrier.

As a non-limiting example, if the first UE 102A is assigned to the second BWP 106B, and has been identified as a high data UE 102 during a period when utilization of the second BWP 106B is above a utilization threshold, the base station 104 may use UE capability information 118 associated with the first UE 102A to determine whether the first UE 102A supports carrier aggregation with a combination of carriers that could or would be associated with resources within the second bandwidth 110 of the second BWP 106B as well as with additional resources 112 within the third bandwidth 114 that is not associated with the second BWP 106B. Although the resources within the second bandwidth 110 of the second BWP 106B and the additional resources 112 within the third bandwidth 114 that is not associated with the second BWP 106B may be part of the same carrier, an indication in the UE capability information 118 that the first UE 102A does support carrier aggregation for such a combination of carriers may allow the base station 104 to determine that the first UE 102A is capable of using additional resources 112 within the third bandwidth 114 instead of or in addition to resources of the second BWP 106B to which the first UE 102A is currently assigned.

UE capability information 118 may also, or alternately, indicate that a corresponding UE 102 supports cross-carrier scheduling. Cross-carrier scheduling may allow the UE 102 to receive and interpret instructions from the base station 104 that cause the UE 102 to access and use resources in multiple carriers, within one or more spectrum bands, that have been allocated by the base station 104 for the UE 102, with or without the use of carrier aggregation. As an example, support for cross-carrier scheduling in association with a spectrum band that corresponds to overlapping spectrum bands, such as the 700 MHz B12 and B85 LTE bands or the 700 MHz n12 and n85 5G NR bands, may indicate that the UE 102 is capable of using resources within multiple corresponding carriers without the use of carrier aggregation.

Accordingly, if the UE capability information 118 indicates that the UE 102 supports cross-carrier scheduling, the base station 104 may determine that the UE 102 is capable of accessing additional resources outside an assigned BWP 106 instead of or in addition to resources inside the assigned BWP 106. For instance, if the UE capability information 118 indicates that the UE 102 supports cross-carrier scheduling in association with a spectrum band corresponding to the BWPs 106, the base station 104 may determine that the UE 102 is capable of following instructions in a scheduling message 116 from the base station 104 that would cause the UE 102 access and use resources that are outside the BWP 106 assigned to the UE 102, instead of or in addition to resources inside the assigned BWP 106, even if such resources inside and outside the BWP 106 are associated with the same carrier.

As a non-limiting example, if the first UE 102A is assigned to the second BWP 106B, and has been identified as a high data UE 102 during a period when utilization of the second BWP 106B is above a utilization threshold, the base station 104 may use UE capability information 118 associated with the first UE 102A to determine whether the first UE 102A supports cross-carrier scheduling in association with a spectrum band that encompasses the second bandwidth 110 of the second BWP 106B and the third bandwidth 114 that is not associated with the second BWP 106B. Although the resources within the second bandwidth 110 of the second BWP 106B and the additional resources 112 within the third bandwidth 114 that is not associated with the second BWP 106B may be part of the same carrier, an indication in the UE capability information 118 that the first UE 102A does support cross-carrier scheduling may allow the base station 104 to determine that the first UE 102A is capable of using additional resources 112 within the third bandwidth 114 instead of or in addition to resources of the second BWP 106B to which the first UE 102A is currently assigned.

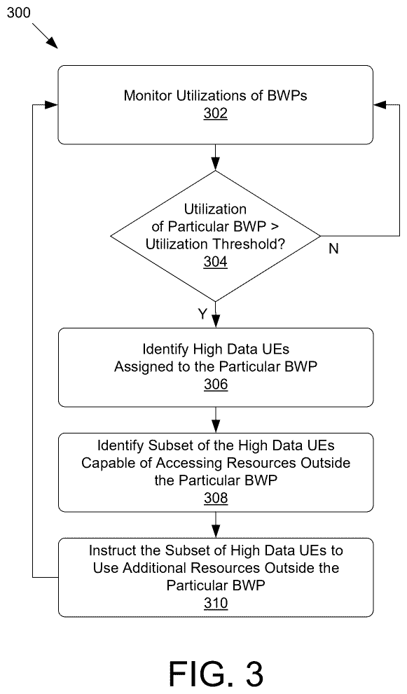

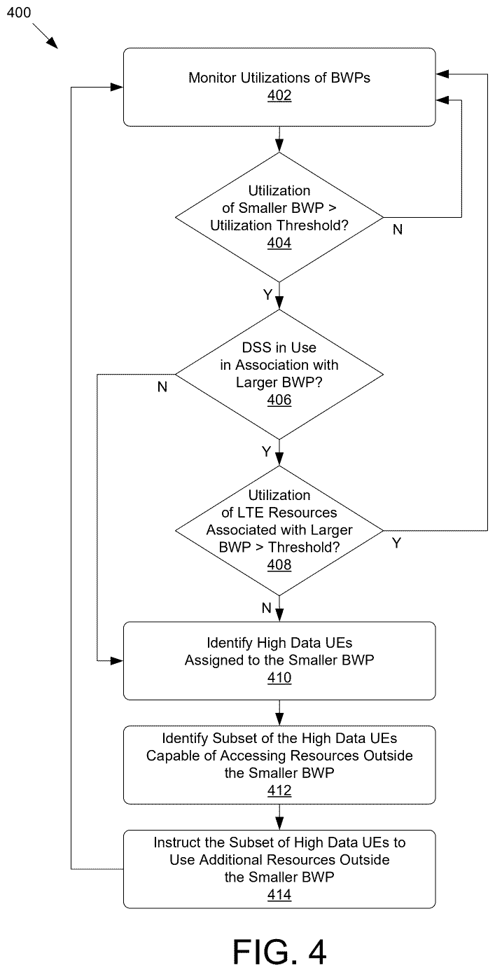

Overall, the base station 104 may use UE capability information 118 to determine whether high data UEs 102 support using additional resources 112 outside of an assigned BWP 106, for instance if UE capability information 118 indicates that the high data UEs 102 support cross-carrier scheduling and/or carrier aggregation and are in turn capable of accessing resources anywhere within a spectrum band that encompasses the assigned BWP 106 and the additional resources 112 outside of the assigned BWP 106. If the base station 104 determines that one or more high data UEs 102 do support using such additional resources 112 outside of their assigned BWP 106, at a time when utilization of the assigned BWP 106 exceeds a corresponding utilization threshold, the base station 104 may allocate such additional resources 112 to the high data UEs 102 and send scheduling messages 116 that instruct the high data UEs 102 to use the allocated additional resources 112 instead of or in addition to resources within the assigned BWP 106. Example processes that may be used by the base station 104 to shift at least a portion of data usage associated with high data UEs 102 to additional resources 112 outside an assigned BWP 106 is discussed further below with respect to FIG. 3 and FIG. 4.

The base station 104 may be configured to monitor utilization of BWPs 106 and, if such utilization levels exceed corresponding thresholds, send scheduling messages 116 to shift at least a portion of data usage associated with high data UEs 102 to additional resources outside of the BWPs 106 on a relatively frequent basis, such as every millisecond. As a non-limiting example, if the base station 104 determines that utilization of a BWP 106 exceeds a utilization threshold, the base station 104 may be configured to, within a millisecond or other relatively short period of time, identify one or more high data UEs 102 assigned to that BWP 106, allocate additional resources 112 outside of the BWP 106 to the identified high data UEs 102, and send corresponding scheduling message 116 to the high data UEs 102.

In some examples, when the base station 104 sends a scheduling message 116 instructing a high data UE 102 to use additional resources outside of a BWP 106 assigned to that high data UE 102, the base station 104 may also send corresponding power control instructions to the high data UE 102 in the scheduling message 116 or in a separate message. The power control instructions may cause the high data UE 102 to adjust power levels used to monitor and/or use resources in the assigned BWP 106 and/or outside the assigned BWP 106, and thereby avoid decreasing battery life and/or increasing power usage of the high data UE 102 in association with the techniques described herein. In some examples, the base station 104 may determine power levels to express in the power control instructions based at least in part on radio frequency (RF) conditions, whether the high data UE 102 is using techniques such as carrier aggregation and/or cross-carrier scheduling, power resources available to the high data UE 102, and/or other factors.

As a non-limiting example, UE 102A may be assigned to BWP 106B and may initially be configured to use a maximum of 26 decibels (dBs) of power to monitor resources associated with BWP 106B. However, if the base station 104 uses a scheduling message 116 to cause UE 102A to also monitor and use additional resources 112 that are not associated with BWP 106B, the scheduling message 116 or a separate message may include power control instructions that cause UE 102A to use 23 dBs of power, or other power level lower than the 26 dB maximum power level, to monitor resources associated with BWP 106B. The power control instructions may also cause UE 102A to use a remainder of the 26 dB maximum power level to monitor the additional resources 112 outside of BWP 106B that are allocated to UE 102A. Accordingly, the power control instructions may cause UE 102A to continue using a maximum of 26 dBs of power when monitoring both the resources in BWP 106B and the additional resources 112 outside BWP 106B, and thereby avoid causing UE 102A to consume additional power when using allocated additional resources 112 outside of BWP 106B.

As discussed above, identifying high data UEs 102 and shifting at least a portion of their usage from an assigned BWP 106 to additional resources 112 outside the assigned BWP 106 may reduce or avoid congestion in the assigned BWP 106, and/or may lead to a more efficient usage of the additional resources 112 outside the assigned BWP 106. However, in some examples, the base station 104 may be configured to avoid causing high data UEs 102 to use resources 112 outside their assigned BWP 106 if doing so would increase utilization of resources associated with another BWP 106 beyond a threshold level. As a non-limiting example, although the base station 104 may instruct a compatible high data UE 102 assigned to the second BWP 106B to use additional resources 112 within the third bandwidth 114 outside the second BWP 106B when utilization of the second BWP 106B exceeds a corresponding threshold, the base station 104 may avoid sending such instructions to the high data UE 102 if utilization of the first BWP 106A that encompasses the third bandwidth 114 already exceeds a corresponding utilization threshold.

Similarly, the base station 104 may be configured to avoid causing high data UEs 102 to use resources 112 outside their assigned BWP 106 if doing so would negatively impact resources and/or user experiences associated with a different radio access technology, such as LTE. For instance, Dynamic Spectrum Sharing (DSS) may allow a 5G gNB and an LTE eNB, such as an eNB co-located at the same base station 104 as the gNB or at a different base station, to both use resources associated with the same frequencies and/or the same spectrum band. As discussed above, the base station 104 may be able to instruct high data UEs 102 assigned to a particular BWP 106 to use additional resources 112 outside that assigned BWP 106. However, if those additional resources 112 are also used by an eNB and an LTE utilization level of the additional resources 112 exceeds a threshold, the base station 104 may avoid causing the high data UEs 102 to use the additional resources 112 outside their assigned BWP 106 in order to avoid increasing usage the additional resources 112 that may be likely to negatively impact user experiences of LTE users. An example process that may be used by the base station 104 in situations in which DSS may be in use is discussed further below with respect to FIG. 4.

### Example Architecture

FIG. 2 shows an example 200 of a system architecture for the base station 104, in accordance with various examples. The base station 104 may be a 5G gNB. As discussed above, in some examples such a gNB may also be associated with a corresponding LTE eNB or other types of base stations or access points in an access network. As shown, the base station 104 may include processor(s) 202, memory 204, and transmission interfaces 206.

The processor(s) 202 may be a central processing unit (CPU) or any other type of processing unit. Each of the one or more processor(s) 202 may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. The processor(s) 202 may also be responsible for executing all computer-executable instructions and/or computer applications stored in the memory 204.

In various examples, the memory 204 may include system memory, which may be volatile (such as RAM), non-volatile (such as ROM, flash memory, etc.) or some combination of the two. The memory 204 may also include additional data storage devices (removable and/or non-removable) such as, for example, magnetic disks, optical disks, or tape. Memory 204 may further include non-transitory computer-readable media, such as volatile and nonvolatile, removable and non-removable media implemented in any method or technology for storage of information, such as computer readable instructions, data structures, program modules, or other data. System memory, removable storage, and non-removable storage are all examples of non-transitory computer-readable media. Examples of non-transitory computer-readable media include, but are not limited to, RAM, ROM, EEPROM, flash memory or other memory technology, CD-ROM, DVD, or other optical storage, magnetic cassettes, magnetic tape, magnetic disk storage or other magnetic storage devices, or any other non-transitory medium which may be used to store the desired information and which may be accessed by the base station 104. Any such non-transitory computer-readable media may be part of the base station 104.

The memory 204 may store computer-readable instructions and/or other data associated with operations of the base station 104. For example, the memory 204 may store computer-readable instructions and/or other data associated with a BWP utilization determiner 208, a threshold determiner 210, a resource scheduler 212, and/or other modules and data 214.

The BWP utilization determiner 208 may be configured to monitor and/or predict utilization of resources associated with BWPs 106. As an example, the BWP utilization determiner 208 may be configured to determine current utilizations of resources associated with BWPs 106 substantially in real time, for instance based on how many PRBs associated with each BWP 106 the base station 104 has allocated to UEs 102 and/or how many PRBs associated with the BWPs 106 are currently being used by UEs 102. As another example, the BWP utilization determiner 208 may be configured to predict future utilizations of resources associated with BWPs 106 and/or future changes to the utilizations of resources associated with BWPs 106, for instance using AI and/or ML models, historical patterns, predefined rules, and/or other systems.

The threshold determiner 210 may be configured to determine utilization thresholds associated with BWPs 106 and/or other elements. If utilization of a particular BWP 106 determined by the BWP utilization determiner 208 exceeds, or is predicted to exceed, a utilization threshold determined by the threshold determiner 210, the base station 104 may instruct high data UEs 102 assigned to that particular BWP 106 to use additional resources 112 outside the particular BWP 106. In some examples, the threshold determiner 210 may be configured with predefined utilization thresholds associated with BWPs 106. As a non-limiting example, the threshold determiner 210 may use a predefined utilization threshold of 70%, or other higher or lower predefined utilization threshold, for a particular BWP 106. In other examples, the threshold determiner 210 may be configured to dynamically adjust a utilization threshold associated with a BWP 106, for instance to increase or decrease the utilization threshold at different times of day or in association with other factors based on AI and/or ML models, historical patterns, predefined rules, and/or other systems. In some examples, the threshold determiner 210 may also or alternately determine other types of thresholds, such as thresholds associated with utilization of LTE resources that correspond to 5G NR resources available to the base station 104.

The resource scheduler 212 may be configured to allocate resources to UEs 102, to schedule use of the allocated resources for uplink and/or downlink transmissions between the base station 104 and the UEs 102, and/or to perform other operations that cause UEs 102 to use allocated resources. The resource scheduler 212 may cause the base station 104 to send scheduling messages 116 to the UEs 102 that identify particular PRBs and/or other resources allocated to the UEs 102, that identify scheduling information indicating when and/or how the UEs 102 are to access and use the allocated resources for uplink and/or downlink transmissions, and/or other DCI or other information associated with allocation and/or scheduling of resources.

As described herein, UEs 102 connected to the base station 104 may be assigned to particular BWPs 106. Accordingly, the resource scheduler 212 may allocate resources of those BWPs 106 to the UEs 102. However, when utilization of a particular BWP 106 determined by the BWP utilization determiner 208 exceeds, or is predicted to exceed, a utilization threshold determined by the threshold determiner 210, the resource scheduler 212 may identify high data UEs 102 assigned to that particular BWP 106, allocate additional resources outside the particular BWP 106 to the high data UEs 102, and send scheduling messages 116 that instruct the high data UEs 102 to use the allocated additional resources outside the particular BWP 106.

The other modules and data 214 may be utilized by the base station 104 to perform or enable performing any action taken by the base station 104. The other modules and data 214 may include a platform, operating system, firmware, and/or applications, and data utilized by the platform, operating system, firmware, and/or applications.

The transmission interfaces 206 may include one or more modems, receivers, transmitters, antennas, error correction units, symbol coders and decoders, processors, chips, application specific integrated circuits (ASICs), programmable circuit (e.g., field programmable gate arrays), firmware components, and/or other components that may establish connections with UEs 102, other base stations or RAN elements, elements of a core network, and/or other network elements, and may transmit data over such connections. For example, the transmission interfaces 206 may establish a connection with a UE 102 over an air interface. The transmission interfaces 206 may also support transmissions using one or more radio access technologies, such as 5G NR. The transmission interfaces 206 may also be used by the base station 104 to send data to, and/or receive data from, UEs 102 in association with resources of BWPs 106 assigned to the UEs 102 and/or other resources 112 outside assigned BWPs 106, for instance as determined by the resource scheduler 212. As an example, if a UE 102 is assigned to BWP 106B, the resource scheduler 212 may determine that due to congestion in BWP 106B and/or other issues, the transmission interfaces 206 should use certain resources 112 outside BWP 106B to transmit at least some data to that UE 102.

### Example Operations

FIG. 3 shows a flowchart of an example method 300 for causing high data UEs 102 assigned to a BWP 106 to use additional resources outside that BWP 106. The method 300 shown in FIG. 3 may be performed by one or more elements of the base station 104. An example system architecture for the base station 104 is described above with respect to FIG. 2.

At block 302, the base station 104 may monitor utilizations of BWPs 106 of a carrier provided by the base station 104. As described above, the base station 104 may associate different sets of resources with corresponding BWPs 106. The base station 104 may assign different sets of UEs 102 to different BWPs 106, and at block 302 the base station 104 may determine current and/or predicted utilizations of the BWPs 106 by the UEs 102. The base station 104 may determine the utilizations of the BWPs 106 at block 302 based on many PRBs associated with each BWP 106 the base station 104 has allocated to UEs 102, how many PRBs associated with the BWPs 106 are currently being used by UEs 102, other metrics associated with current usage of resources associated with the BWPs 106, predictions of future usage of resources associated with the BWPs 106, predictions of future changes to usage of resources associated with the BWPs 106, and/or other factors.

At block 304, the base station 104 may determine whether a utilization of a particular BWP 106 exceeds a corresponding utilization threshold. In some examples, the particular BWP 106 may be a BWP 106 that has a smaller bandwidth than another BWP 106 of the carrier that is provided by the base station 104. As a non-limiting example, the particular BWP 106 may be the second BWP 106B shown in FIG. 1 that has a second bandwidth 110 that is smaller than the first bandwidth 108 of the first BWP 106A.

In some examples, the utilization threshold used by the base station 104 at block 304 may be a predefined threshold. As a non-limiting example, the utilization threshold may be set to a 70% allocation or usage level of PRBs or other resources associated with the particular BWP 106, or another higher or lower predefined threshold. In other examples, the utilization threshold used by the base station 104 at block 304 may be a dynamically-determined threshold that the base station 104 may adjust over time based on predictions, historical patterns, and/or other factors.

If the utilization of the particular BWP 106 does not exceed the corresponding utilization threshold (Block 304—No), the base station 104 may continue monitoring utilizations of the BWPs 106 at block 302. However, if the utilization of the particular BWP 106 does exceed the corresponding utilization threshold (Block 304—Yes), the base station 104 may identify one or more high data UEs 102 that are assigned to the particular BWP 106 at block 306.

For example, at block 306 the base station 104 may identify a set of UEs 102 that are currently assigned to the particular BWP 106. The base station 104 may also determine current and/or predicted usage of resources of the particular BWP 106 by the UEs 102 currently assigned to the particular BWP 106, and identify a subset of those UEs 102 as high data UEs 102 at block 306. As a non-limiting example, the base station 104 may identify 10% of the UEs 102 assigned to the particular BWP 106 that are currently using, or are predicted to use, the highest amounts of data among all of the UEs 102 assigned to the particular BWP 106, and to consider those UEs 102 to be high data UEs 102. In other examples, the base station 104 may be configured to use any other percentage or number to identify a set of high data UEs 102 that are using more data than the rest of the UEs 102 assigned to the particular BWP 106.

At block 308, the base station 104 may identify a subset of the high data UEs 102, identified at block 306, that are capable of accessing resources outside of the particular BWP 106 to which they are assigned. For example, the base station 104 may use UE capability information 118 provided by the high data UEs 102, to determine which of the high data UEs 102 support techniques such as carrier aggregation, cross-carrier scheduling, and/or other techniques indicating that the high data UEs 102 are capable of accessing resources anywhere within a spectrum band that encompasses the particular BWP 106 and additional resources outside of the particular BWP 106.

At block 310, the base station 104 may instruct the subset of the high data UEs 102, identified at block 308 as being capable of accessing resources outside of the particular BWP 106, to use additional resources outside of the particular BWP 106. For example, the base station 104 may allocate additional resources outside of the particular BWP 106 to the subset of the high data UEs 102. The base station 104 may also use resources of the particular BWP 106 to send scheduling messages 116 to the high data UEs 102 that identify additional resources outside the particular BWP 106 that have been allocated to the high data UEs 102, and that cause the high data UEs 102 to use the allocated additional resources for at least a portion of uplink and/or downlink transmissions.

As a non-limiting example, if the particular BWP 106 is the second BWP 106B shown in FIG. 1, at block 310 the base station 104 may allocate additional resources 112 within the third bandwidth 114 outside of the second BWP 106B to a subset of high data UEs 102 assigned to the second BWP 106B that are capable of accessing those additional resources 112. The base station 104 may also send scheduling messages 116 to such high data UEs 102 via resources of the second BWP 106B, to cause the high data UEs 102 to use the allocated additional resources 112 in the third bandwidth 114 for at least a portion of uplink and/or downlink transmissions. As shown in FIG. 1, the additional resources 112 in the third bandwidth 114 allocated to high data UEs 102 assigned to the second BWP 106B may also be encompassed by the first bandwidth 108 of the first BWP 106A to which the high data UEs 102 are not assigned.

In some examples, the base station 104 may also send corresponding power control instructions to the high data UEs 102 at block 310, for instance to adjust power levels that the high data UEs 102 use to monitor and/or use resources in the particular BWP 106 and/or the additional resources outside the particular BWP 106. The base station 104 may also continue monitoring utilizations of the BWPs 106 at block 302.

By instructing the subset of the high data UEs 102 to use additional resources outside of the particular BWP 106 for at least a portion of uplink and/or downlink transmissions at block 310, usage of the high data UEs 102 may be shifted at least in part outside of the particular BWP 106 to the additional resources. Accordingly, congestion in the particular BWP 106 may be reduced or avoided. Additionally, underutilization of spectrum associated with the additional resources may be reduced or avoided, for instance by causing the high data UEs 102 assigned to the particular BWP 106 to use the additional resources in that spectrum in addition to UEs 102 assigned to a different BWP 106 that also encompasses that spectrum. As discussed further below with respect to FIG. 4, in some examples the base station 104 may also determine whether DSS is in use with respect to the additional resources, and determine whether to instruct high data UEs 102 to use the additional resources based at least in part on an LTE utilization level associated with the additional resources.

FIG. 4 shows a flowchart of an example method 400 for causing high data UEs 102 assigned to one BWP 106 to use additional resources outside that BWP 106 that may also be associated with a different BWP and with an LTE eNB via DSS. The method 400 shown in FIG. 4 may be performed by one or more elements of the base station 104. An example system architecture for the base station 104 is described above with respect to FIG. 2.

At block 402, the base station 104 may monitor utilizations of BWPs 106 of a carrier provided by the base station 104. As described above, the base station 104 may associate different sets of resources with corresponding BWPs 106, including a smaller BWP 106 with a smaller bandwidth and a larger BWP 106 with a larger bandwidth. The smaller bandwidth of the smaller BWP 106 may be encompassed by the larger bandwidth of the larger BWP 106, for example as shown in FIG. 1 with respect to BWP 106A and BWP 106B.

The base station 104 may assign different sets of UEs 102 to different BWPs 106, and at block 402 the base station 104 may determine current and/or predicted utilizations of the BWPs 106 by the UEs 102. The base station 104 may determine the utilizations of the BWPs 106 at block 402 based on many PRBs associated with each BWP 106 the base station 104 has allocated to UEs 102, how many PRBs associated with the BWPs 106 are currently being used by UEs 102, other metrics associated with current usage of resources associated with the BWPs 106, predictions of future usage of resources associated with the BWPs 106, predictions of future changes to usage of resources associated with the BWPs 106, and/or other factors.

At block 404, the base station 104 may determine whether utilization of the smaller BWP 106 exceeds a corresponding utilization threshold. In some examples, the utilization threshold used by the base station 104 at block 404 may be a predefined threshold. As a non-limiting example, the utilization threshold may be set to a 70% allocation or usage level of PRBs or other resources associated with the smaller BWP 106, or another higher or lower predefined threshold. In other examples, the utilization threshold used by the base station 104 at block 404 may be a dynamically-determined threshold that the base station 104 may adjust over time based on predictions, historical patterns, and/or other factors.

If the utilization of the smaller BWP 106 does not exceed the corresponding utilization threshold (Block 404—No), the base station 104 may continue monitoring utilizations of the BWPs 106 at block 402. However, if the utilization of the smaller BWP 106 does exceed the corresponding utilization threshold (Block 404—Yes), the base station 104 may determine at block 406 whether DSS is being used in association with LTE resources that correspond to the larger BWP 106.

DSS may allow at least a portion of the spectrum associated with the larger BWP 106, provided by the 5G NR base station 104, to be shared and/or used by a corresponding LTE eNB. Accordingly, at block 406, the base station 104 may determine whether DSS is being used to share resources associated with the larger BWP 106 with an LTE eNB.

If the base station 104 determines that DSS is being used in association with LTE resources that correspond to the larger BWP 106 (Block 406—Yes), the base station 104 may determine at block 408 whether a current or predicted utilization of the LTE resources exceeds a threshold. In some examples, the threshold may be a preset utilization threshold such as 70% or any other higher or lower utilization threshold. In other examples, the threshold may be a dynamically-determined utilization threshold. The base station 104 may, in some examples, communicate with the corresponding LTE eNB, a core network element, or other elements of the telecommunication network to determine the current or predicted utilization of the corresponding LTE resources.

If the base station 104 determines that the current or predicted utilization of the LTE resources exceeds the threshold (Block 408—Yes), the base station 104 may determine not to shift usage of high data UEs 102 assigned to the smaller BWP 106 to additional resources outside the smaller BWP 106, in order to avoid increasing congestion associated with the LTE resources and/or to avoid otherwise negatively impacting user experiences of UEs 102 using the LTE resources. However, the base station 104 may continue monitoring utilizations of the BWPs 106 at block 402.

If the base station 104 determines that DSS is in use with respect to LTE resources corresponding to the larger BWP 106 but the utilization of those LTE resources does not exceed the threshold (Block 408—No), or the base station determines that DSS is not in use with respect to LTE resources corresponding to the larger BWP 106 (Block 406—No), the base station 104 may identify one or more high data UEs 102 that are assigned to the smaller BWP 106 at block 410.

For example, at block 410 the base station 104 may identify a set of UEs 102 that are currently assigned to the smaller BWP 106. The base station 104 may also determine current and/or predicted usage of resources of the smaller BWP 106 by the UEs 102 currently assigned to the smaller BWP 106, and identify a subset of those UEs 102 as high data UEs 102 at block 410. As a non-limiting example, the base station 104 may identify 10% of the UEs 102 assigned to the smaller BWP 106 that are currently using, or are predicted to use, the highest amounts of data among all of the UEs 102 assigned to the smaller BWP 106, and to consider those UEs 102 to be high data UEs 102. In other examples, the base station 104 may be configured to use any other percentage or number to identify a set of high data UEs 102 that are using more data than the rest of the UEs 102 assigned to the smaller BWP 106.

At block 412, the base station 104 may identify a subset of the high data UEs 102, identified at block 410, that are capable of accessing resources outside of the smaller BWP 106 to which they are assigned. For example, the base station 104 may use UE capability information 118 provided by the high data UEs 102, to determine which of the high data UEs 102 support techniques such as carrier aggregation, cross-carrier scheduling, and/or other techniques indicating that the high data UEs 102 are capable of accessing resources anywhere within a spectrum band that encompasses the smaller BWP 106 and additional resources outside of the smaller BWP 106.

At block 414, the base station 104 may instruct the subset of the high data UEs 102, identified at block 412 as being capable of accessing resources outside of the smaller BWP 106, to use additional resources outside of the smaller BWP 106. For example, the base station 104 may allocate additional resources outside of the smaller BWP 106 to the subset of the high data UEs 102. The base station 104 may also use resources of the smaller BWP 106 to send scheduling messages 116 to the high data UEs 102 that identify additional resources outside the smaller BWP 106 that have been allocated to the high data UEs 102, and that cause the high data UEs 102 to use the allocated additional resources for at least a portion of uplink and/or downlink transmissions.

As a non-limiting example, if the smaller BWP 106 is the second BWP 106B shown in FIG. 1 and the larger BWP 106 is the first BWP 106A shown in FIG. 1, at block 414 the base station 104 may allocate additional resources 112 within the third bandwidth 114 outside of the second BWP 106B to a subset of high data UEs 102 assigned to the second BWP 106B that are capable of accessing those additional resources 112. The base station 104 may also send scheduling messages 116 to such high data UEs 102 via resources of the second BWP 106B, to cause the high data UEs 102 to use the allocated additional resources 112 in the third bandwidth 114 for at least a portion of uplink and/or downlink transmissions. As shown in FIG. 1, the additional resources 112 in the third bandwidth 114 allocated to high data UEs 102 assigned to the second BWP 106B may also be encompassed by the first bandwidth 108 of the first BWP 106A to which the high data UEs 102 are not assigned.

In some examples, the base station 104 may also send corresponding power control instructions to the high data UEs 102 at block 414, for instance to adjust power levels that the high data UEs 102 use to monitor and/or use resources in the smaller BWP 106 and/or the additional resources outside the smaller BWP 106. The base station 104 may also continue monitoring utilizations of the BWPs 106 at block 402.

By instructing the subset of the high data UEs 102 to use additional resources outside of the smaller BWP 106 for at least a portion of uplink and/or downlink transmissions at block 414, usage of the high data UEs 102 may be shifted at least in part outside of the smaller BWP 106 to the additional resources. Accordingly, congestion in the smaller BWP 106 may be reduced or avoided. Additionally, underutilization of spectrum associated with the additional resources may be reduced or avoided, for instance by causing the high data UEs 102 assigned to the smaller BWP 106 to use the additional resources in that spectrum in addition to UEs 102 assigned to the larger BWP 106 that also encompasses that spectrum. However, if DSS is in use in association with those additional resources and utilization of the corresponding LTE resources is higher than an associated threshold, the base station 104 may avoid causing such high data UEs 102 assigned to the smaller BWP 106 to use the additional resources in order to avoid negative impacts to user experiences associated with the LTE resources.

### CONCLUSION

Although the subject matter has been described in language specific to structural features and/or methodological acts, it is to be understood that the subject matter is not necessarily limited to the specific features or acts described above. Rather, the specific features and acts described above are disclosed as example embodiments.

Additionally, although the descriptions provided herein may be in the context of certain radio access technologies, networks, and network topologies, such as 5G/NR mobile communications, the proposed concepts, schemes, and any variations thereof may be implemented in, for and by other types of radio access technologies, networks, and network topologies. Such radio access technologies, networks, and network topologies may include, for example and without limitation, Long-Term Evolution (LTE), Internet-of-Things (IoT), Narrow Band Internet of Things (NB-IoT), vehicle-to-everything (V2X), fixed wireless internet, and non-terrestrial network (NTN) communications. Thus, the scope of the disclosure is not limited to the examples described herein.

What is claimed is:

1. A method, comprising:
determining, by a base station of a telecommunication network, that utilization of resources associated with a particular bandwidth part of a carrier exceeds a utilization threshold;
identifying, by the base station, a set of user equipments (UEs) that are assigned to the particular bandwidth part;
identifying, by the base station, a high data UE within the set of UEs assigned to the particular bandwidth part;
determining, by the base station, that the high data UE is capable of accessing additional resources outside the particular bandwidth part; and
instructing, by the base station, the high data UE to use the additional resources outside the particular bandwidth part in addition to allocated resources of the particular bandwidth part.

2. The method of claim 1, wherein the base station determines that the high data UE is capable of accessing the additional resources outside the particular bandwidth part based on UE capability information provided by the high data UE.

3. The method of claim 2, wherein the UE capability information indicates that the high data UE supports carrier aggregation of a set of carriers that spans:
a first bandwidth of the particular bandwidth part; and
a second bandwidth outside the particular bandwidth part that encompasses the additional resources.

4. The method of claim 2, wherein the UE capability information indicates that the high data UE supports cross-carrier scheduling in association with a spectrum that spans:
a first bandwidth of the particular bandwidth part; and
a second bandwidth outside the particular bandwidth part that encompasses the additional resources.

5. The method of claim 1, wherein:
the base station provides a first bandwidth part having a first bandwidth and a second bandwidth part having a second bandwidth smaller than the first bandwidth,
the particular bandwidth part is the second bandwidth part,
the first bandwidth part encompasses the second bandwidth of the second bandwidth part and a third bandwidth outside of the second bandwidth part, and
the additional resources are associated with the third bandwidth.

6. The method of claim 5, wherein the high data UE does not support being assigned to a bandwidth part having the first bandwidth.

7. The method of claim 1, wherein the base station instructing the high data UE to use the additional resources comprises:
allocating, by the base station, the additional resources to the high data UE; and
transmitting, by the base station via the particular bandwidth part, a scheduling message that causes the high data UE to use the additional resources for at least a portion of an uplink transmission or a downlink transmission.

8. The method of claim 1, wherein identifying the high data UE comprises determining, by the base station, that the high data UE is currently using, or is predicted to use, a higher amount of data than a majority of other UEs within the set of UEs assigned to the particular bandwidth part.

9. The method of claim 1, wherein at least one of the utilization or the utilization threshold is dynamically determined based on a prediction by the base station.

10. The method of claim 1, further comprising transmitting, by the base station, power control instructions that adjust power levels used by the high data UE to use:
the additional resources outside the particular bandwidth part, and
the allocated resources of the particular bandwidth part.

11. The method of claim 1, wherein the base station instructs the high data UE to use the additional resources outside the particular bandwidth part, in addition to the allocated resources of the particular bandwidth part, in response to determining that the additional resources do not correspond to Long-Term Evolution (LTE) resources being used in association with 5G New Radio (NR) resources via Dynamic Spectrum Sharing (DSS).

12. The method of claim 1, wherein the base station instructs the high data UE to use the additional resources outside the particular bandwidth part, in addition to the allocated resources of the particular bandwidth part, in response to determining that:
the additional resources correspond to Long-Term Evolution (LTE) resources being used in association with 5G New Radio (NR) resources via Dynamic Spectrum Sharing (DSS); and
a utilization level of the LTE resources does not exceed a threshold.

13. A base station of a telecommunication network, comprising:
one or more processors, and
memory storing computer-executable instructions that, when executed by the one or more processors, cause the one or more processors to perform operations comprising:
determining that utilization of resources associated with a particular bandwidth part of a carrier exceeds a utilization threshold;
identifying a high data UE assigned to the particular bandwidth part;
determining that the high data UE is capable of accessing additional resources outside the particular bandwidth part; and
instructing the high data UE to use the additional resources outside the particular bandwidth part in addition to allocated resources of the particular bandwidth part.

14. The base station of claim 13, wherein the computer-executable instructions cause the one or more processors to determine that the high data UE is capable of accessing the additional resources outside the particular bandwidth part based on UE capability information, provided by the high data UE, indicating that the high data UE supports at least one of carrier aggregation or cross-carrier scheduling associated with a set of carriers within spectrum encompassing the particular bandwidth part and the additional resources.

15. The base station of claim 13, wherein instructing the high data UE to use the additional resources outside the particular bandwidth part in addition to the allocated resources of the particular bandwidth part comprises:
allocating the additional resources to the high data UE; and
transmitting a scheduling message that causes the high data UE to use the additional resources for at least a portion of an uplink transmission or a downlink transmission.

16. The base station of claim 13, wherein instructing the high data UE to use the additional resources outside the particular bandwidth part in addition to the allocated resources of the particular bandwidth part is performed in response to determining that:
the additional resources do not correspond to Long-Term Evolution (LTE) resources being used in association with 5G New Radio (NR) resources via Dynamic Spectrum Sharing (DSS), or
the additional resources correspond to the LTE resources being used in association with 5G NR resources via DSS and a utilization level of the LTE resources does not exceed a threshold.

17. One or more non-transitory computer-readable media storing computer-executable instructions that, when executed by one or more processors of a base station of a telecommunication network, cause the base station to:
determine that utilization of resources associated with a particular bandwidth part of a carrier exceeds a utilization threshold;
identify a high data UE assigned to the particular bandwidth part;
determine that the high data UE is capable of accessing additional resources outside the particular bandwidth part; and
instruct the high data UE to use the additional resources outside the particular bandwidth part in addition to allocated resources of the particular bandwidth part.

18. The one or more non-transitory computer-readable media of claim 17, wherein the base station determines that the high data UE is capable of accessing the additional resources outside the particular bandwidth part based on UE capability information, provided by the high data UE, indicating that the high data UE supports at least one of carrier aggregation or cross-carrier scheduling associated with a set of carriers within spectrum encompassing the particular bandwidth part and the additional resources.

19. The one or more non-transitory computer-readable media of claim 17, wherein the base station instructs the high data UE to use the additional resources outside the particular bandwidth part in addition to the allocated resources of the particular bandwidth part by:
allocating the additional resources to the high data UE; and
transmitting a scheduling message that causes the high data UE to use the additional resources for at least a portion of an uplink transmission or a downlink transmission.

20. The one or more non-transitory computer-readable media of claim 17, wherein the base station instructs the high data UE to use the additional resources outside the particular bandwidth part in addition to the allocated resources of the particular bandwidth part in response to determining that:
the additional resources do not correspond to Long-Term Evolution (LTE) resources being used in association with 5G New Radio (NR) resources via Dynamic Spectrum Sharing (DSS), or
the additional resources correspond to the LTE resources being used in association with 5G NR resources via DSS and a utilization level of the LTE resources does not exceed a threshold.
